(19) United States
(12) Patent Application Publication
(10) Pub. No.: US 2002/0188714 A1
(43) Pub. Date: Dec. 12, 2002

(54) State of activity management method for a radio communications terminal

(76) Inventor: Nicolas Bouthors, Meylan (FR)

Correspondence Address: Robert M. Angus, Westman, Champlin & Kelly, International Centre, Suite 1600, 900 Second Avenue South, Minneapolis, MN, 55402-3319, US

(21) Appl. No.: 10/115,450

(22) Filed: Mar. 29, 2002

(30) Foreign Application Priority Data
Apr. 5, 2001 (FR) FR01 04674

(51) Int. Cl. G06F 15/173

(52) U.S. Cl. 709/223

(57) ABSTRACT

The invention relates to a state of activity management method for at least one terminal in a radio communications network, the said network giving the said terminal access to at least one service.

According to the invention, such a method implements an analysis step by a state of activity management apparatus, analyzing the activity of the said terminal in such a manner as to deduce the state of activity information of the said terminal, the said apparatus being connected to the said radio communications network but not being included in the architecture of the said network, and the said power status information being accessible to at least one service provider internal or external to the said radio communications network.

### FIELD OF THE INVENTION

The field of the invention is that of radio communications. More precisely, the invention concerns the management of the state of activity of terminals in a radio communications network.

### BACKGROUND OF THE INVENTION

The invention applies in particular, but not exclusively, to communications networks of the GRPS (“General Packet Radio System”) type and of the UMTS (“Universal Mobile Telecommunication System”) type.

Such telecommunications networks typically keep a database up to date, called the HLR (“Home Register Locator”) that ensures the management of the network's mobile subscribers. In this manner, each mobile subscriber is registered in a single HLR that contains notably the description of their subscriber rights and the routing information permitting incoming calls to be transmitted to the subscriber. In the framework of a network of the GSM (“Groupe Spécial Mobile”, in English “Special Mobile Group”) type, the international identity of the mobile subscriber (IMSI for “International Mobile Subscriber Identity”) and the RNIS number of the mobile subscriber (MSISDN for “Mobile Station ISDN Number”) are stored in the HLR.

Such HLR registers also dispose of information on the waking state (active or inactive) of the terminals in the radio communications network.

However, this information is not easily accessible, and all the more difficult to exploit, for service providers and radio communications network operators alike. The HLR is a critical system of the radio communications network that is very difficult to open to other systems, internal or external to the network.

This difficulty arises notably from the fact that, in order for a system to access information contained in the HLR and in particular the information concerning the waking state of the network's terminals, it is indispensable that the system be connected to a communications network using a signalling system of the SS7 (Signalling System Number 7) type. It should be noted that SS7 is a normalised signalling system in which a particular route is used to transmit the signal related to a group of circuits or independent of circuits.

Information on the state of activity of the terminals on a radio communications network is particularly useful for service providers, especially when dealing with the transmission of messages of the SMS (“Short Message Service”, a bi-directional system for sending short messages) type.

At present, the transmission of SMS to a mobile terminal requires that a data channel be reserved in advance (functioning in mode circuit).

Such a reservation is particularly expensive, notably when the terminal is in an inactive state and the data channels must be blocked until the terminal is activated and can therefore receive the short message in question.

Another inconvenience of the technique of the prior art is that data channels are rare resources of which the reservation with a view to transmitting SMS might create congestion on the radio communications network.

In addition, the information concerning the waking condition of terminals, available in the HLR, is a rudimentary form of data that can only indicate the active or inactive status of a terminal, and not the terminal user's desire to be contacted or not by different means of communication. Notably, this information does not make it possible for the subscriber to receive short messages of the SMS type without receiving incoming calls.

More generally, an inconvenience of the current technique for managing a terminal's activity condition is that the state of activity information provided by the HLR does not allow for any nuances and does not make it possible for the terminal's user to modulate its activity status.

The objective of the present invention is to do away with these inconveniencies of the prior art.

More precisely, one objective of the present invention is to provide a technique to manage the activity status of radio communications terminals that enables a server, internal or external to the network, to determine the activity status of a terminal. In particular, one objective of the present invention is to enable a server external to the network to determine the activity status of a terminal, even if the server is not connected to a network using a signalling system of the type SS7.

Another objective of the present invention is to implement a technique for activity status management of radio communications terminals which is independent of the operator of the radio communications network in question, notably independent of the HLR implemented in the network.

Another objective of the present invention is to provide a technique for activity status management of radio communications terminals which is simple and inexpensive to implement.

Another objective of the present invention is to provide a technique for activity status management of radio communications terminals which enables service providers to transmit messages, notably those of the type SMS, to terminals at a lower cost in comparison with the techniques of the prior art.

Another objective of the present invention is to provide a technique for waking state management of radio communications terminals which enables service providers to offer value-added services to network subscribers.

Another objective of the present invention is to provide a technique for waking state management of radio communications terminals which enables subscribers to access new services without extra cost in comparison with services of the SMS type of the prior art.

Another objective of the present invention is to provide a technique for sleep status management of radio communications terminals which can be adapted to all types of radio communications networks, in particular to networks of the type GPRS and UMTS.

### SUMMARY OF THE INVENTION

These objectives and others to be mentioned in the following are achieved using a method for the activity status management of at least one terminal in a radio communications network, the said network permitting access from the said terminal to at least one service.

According to the invention, such a method comprises an analysis step, using an activity status management apparatus, of the activity of the said terminal in such a way as to deduce the activity status of the said terminal, the said apparatus being connected to the said radio communications network but not being included in the architecture of the said network, and the said activity status information being accessible to at least one service provider, internal or external to the said radio communications network.

In this manner, the present invention is based upon an entirely new and inventive approach to activity status management of terminals in a radio communications network. The present invention is in fact based upon the introduction of a new apparatus, called an activity status management apparatus, capable of managing information on the activity status of terminals and of making this information available to service providers, internal or external to the network in question. Such an apparatus has the advantage of being independent of the operator of the radio communications network in question.

A service provider wishing for example to transmit content to a mobile terminal can thus query the activity status management apparatus as to the active or inactive status of the terminal, in order to ensure that the terminal is ready to receive the content in question. In this manner, network congestion, as a result of transmitting messages or calls to terminals on standby or by needlessly reserving data channels to transmit messages, calls or any other type of data, can be avoided.

Such a service provider can of course be internal or external to the radio communications network in question, and can notably, in one particular case of the present invention, be the radio communications network operator himself.

Advantageously, the activity status management apparatus comprises:

at least one activity status server implementing the said analysis step;

at least one activity status database implementing a storage step of the said activity status information.

The server and the database can be integrated into one equipment system or can be structured as two distant elements co-operating to constitute the activity status management apparatus of the present invention.

According to one advantageous characteristic of the present invention, the said database is accessible via the said radio communications network and/or via at least one other communications network.

In this manner, the database is accessible to service providers both internal and external to the radio communications network.

According to a first preferred embodiment of the present invention, during the said analysis step, the said activity status server analyses the status of a connection established between an activity status client implemented by the said terminal and the said activity status server, and the said activity status information takes an initial value of “active” when the said connection is open, and a second value of “inactive” when the said connection is broken.

The breaking of the connection thus constitutes, for the activity status server, an indication of the terminal's non-availability.

Advantageously, the said connection is established according to a protocol of the TCP (Transmission Control Protocol) type.

Maintaining such a connection is advantageous in that it is inexpensive. The present invention applies of course also to all other types of connections.

According to an advantageous alternative embodiment of the invention, the said connection is broken after a predetermined maximum period of time and reallocated later on to the said activity status client implemented by the said terminal.

It can henceforth be envisaged, for example, that the activity status server considers that the terminal's activity status remains unchanged during the period separating the connection cut-off and the establishment of a new connection by the terminal.

According to a second preferred embodiment of the present invention, during the analysis step, the said activity status server determines the length of time since reception of the last data packet transmitted by an activity status client implemented by the said terminal to the activity status server, and the said activity status information takes on an initial value of “active” when the said length of time is inferior to a predetermined threshold, and a second value of “inactive” when the said length of time is superior to a predetermined threshold.

In this manner, if the activity status information has not been updated within a predetermined period of time (10 minutes, for example), the activity status server can consider the terminal as having gone into a state of unavailability, and is therefore inactive.

According to a third preferred embodiment of the present invention, during the said analysis step, the said activity status server analyses the contents of a status message transmitted by an activity status client implemented by the said terminal to the said activity status server, in such a manner as to deduce the said activity status information of the said terminal.

This third embodiment can of course be combined with the other two modes of embodiment described above, so as to allow the activity status server to analyse several parameters (such as the contents of a status message transmitted by the terminal, the length of time since reception of the last status message and the connection status), in such a way as to determine the activity status of the terminal in question.

The said analysis step preferably comports in itself a sub-step in which the said activity status information is refined in such a manner as to provide data selectively on the activity status of the said terminal with regard to a mode of transmission associated with a class of service(s).

The terminal can thus, for example, be considered active with regard to the reception of short messages of the SMS type, but inactive with regard to the reception of telephone calls, or vice versa.

According to an advantageous characteristic of the invention, the said status message is a binary message comprising a plurality of bits, each of the said bits being associated with at least one mode of transmission, and during the said refining sub-step, the said activity status server determines the value of each bit and deduces the activity status of the said terminal with regard to the said at least one mode of transmission associated, a bit of value 0, respectively 1, indicating that the said terminal is in an active, respectively inactive, state, for the said transmission modes associated, or vice versa.

More preferably, the said transmission modes belong to the group including:

notification transmission modes

normal voice transmission modes

urgent voice transmission modes

normal data transmission modes

urgent data transmission modes

filtered voice transmission modes

Advantageously, the exchanges between the said activity status client implemented by the said terminal and the said activity status server are carried out according to a definite activity protocol, defining a structure of the said status message.

It can in fact be envisaged that an activity status server manage a plurality of activity protocols, and therefore a plurality of structures associated with status messages, in such a manner as to adapt its exchanges with an activity status client, depending on the characteristics of the terminal which implements it.

According to an advantageous technique of the present invention, the said status message is furthermore a terminal user's identification data.

Such identification data can be for example the user's MSISDN.

It can then be envisaged that the activity status server manage in addition a table associating to each identification data (and therefore to each user) a type of activity protocol.

According to an advantageous characteristic of the invention, the said status message comprises in addition at least one of the following pieces of information:

authentication information;

a public IP (Internet Protocol) address of the said user.

Such authentication information thus makes it possible to be sure of the user's identity and is based on his MSISDN. The IP address indicates furthermore to the activity status server (and therefore to an eventual service provider who might seek to contact the terminal) at what public address the terminal can be contacted.

Such a procedure has the advantage of comprising in addition an availability step in which the said activity status information is made available to at least one of the said service providers by the said activity status database.

According to a first advantageous alternative of the invention, during the said availability step, the said database transmits the said activity status information in reply to a query from the said service provider.

According to a second advantageous alternative of the present invention, the said activity status database implements the said transmission step at each change in value of the said activity status information.

For example, the database informs the service providers who so desire of the terminal's change of status to active or inactive.

More preferably, such a procedure comprises furthermore a transmission step in which the said activity status server transmits an informative message to the said user.

Such an informative message can for example be a notification indicating to the user that he should consult his voice mailbox, or go to a WAP page containing information destined to him.

The format of such an informative message is more preferably of the MIME type (“Multipurpose Internet Mail Extension”).

More generally, such an informative message can use the principles of electronic mail, of the Web or of the SIP protocol (“Session Initiation Protocol”), for example.

More preferably, the said service provider belongs to a group comprising:

presence servers

localisation servers

instant messaging servers (or IM servers)

information broadcast servers

content providers

The present invention also applies of course to all other types of service providers for whom knowing a terminal's activity status is useful or interesting.

The present invention also concerns an activity status server, a service provider and an activity status management apparatus implementing the procedure described above.

### BRIEF DESCRIPTION OF THE DRAWINGS

Other characteristics and advantages of the present invention will become clearer upon reading the following description of a preferred embodiment, given here as a non-limiting, example, embodiment, and the drawings in annex, amongst which:

FIG. 1 presents a block diagram of a system of activity status management for a radio communications terminal according to the invention, implementing an activity status server and an activity status database;

FIG. 2 illustrates an example of exchanges between a radio communications terminal and the activity status server in FIG. 1, enabling the server to determine the terminal's activity status in the framework of a connection of the type TCP;

FIG. 3 describes an example of exchanges between a radio communications terminal and the activity status server of the invention according to the protocol of the type UDP (“User Datagram Protocol”);

FIG. 4 illustrates an example of an embodiment of the invention, in which a content provider transmits a message to a network user using the activity status management apparatus of the invention.

### DETAILED DESCRIPTION OF PREFERRED EMBODIMENTS

The general principle of the invention is based upon the implementation of an activity status management apparatus, capable of determining whether the terminals of a radio communications network are active or inactive, and to which a service provider external to the network can have access.

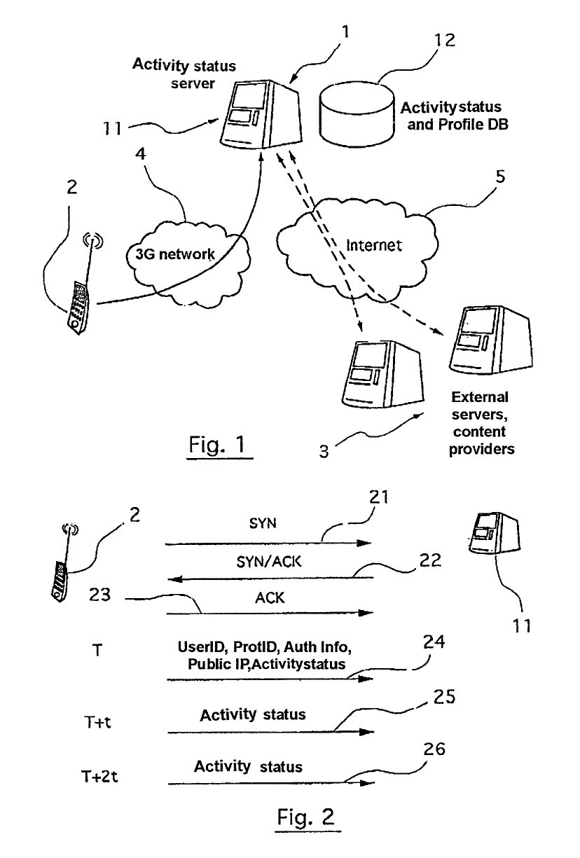

With regard to FIG. 1, an embodiment of the invention is presented, in which the activity status management apparatus 1, independent of the network provider in question, manages activity status information of a radio communications terminal 2, and makes this data available to service or content providers 3 external to the network.

In order to simplify matters, a single radio communications terminal 2 has been shown in FIG. 1. The invention also applies of course to cases where the activity status management apparatus 1 manages activity status information from several radio communications terminals and, more preferably, to the case where the activity status of all the terminals on the network are managed by one or several activity status management apparatuses 1.

In the example illustrated in FIG. 1, the terminal 2 belongs to a radio communications network 4 using the standard UMTS, also called 3G network (for third generation radio communications network). The invention also applies of course to all other types of radio communications networks, particularly to networks using the standard GPRS (also called 2.5G network) or GSM, notably if taken in combination with a protocol of the WAP (“Wireless Application Protocol”) type.

The service providers 3 are, in the example in FIG. 1, linked to an activity status management apparatus 1 by a network 5 of the Internet type, such as for example the World Wide Web. It should be noted that the network 5 can also be of any other type, and can notably be a radio communications network using the standards UMTS, GPRS or GSM.

Service provider 3 here means any server on the radio communications network 5 for which knowing the waking status of the terminal 2 is useful. Such a service provider can be, for example, a content provider, a localisation server of the terminal 2, or an information broadcast server. The service provider 3 can notably be internal or external to the network 4 and, in a particular embodiment of the invention, the service provider 3 can be included in the architecture of the network 4, or be the operator of the network 4 himself.

The activity status management apparatus 1 comprises, following the example of FIG. 1, an activity status server 11, which analyses the activity of the terminal 2 in order to deduce information as to its activity status, and an activity status database 12, which stores the information deduced by the server 11.

The server 11 and the database 12 can be integrated into a single management apparatus 1, or be distant. In the latter case, it can be envisaged, for example, that the server 11 be connected to another communications network, of the Internet type for example. The server 11 and the database 12 comprise in this way the specific means which enable them to exchange data and notably the activity status information of the terminal 2.

According to a first embodiment illustrated in FIG. 1, the terminal 2 disposes of an activity status client which sends a datagram indicating that it is active to the activity status server 11 at regular intervals. When a long period of time goes by without the activity status server 11 receiving a datagram, it deduces that the terminal 2 has turned inactive. It then transmits this information to the database 12, which updates the status information register so that the activity status information associated with the terminal 2 takes on the value of “inactive”, indicating that the terminal is on standby.

It should be clear that in the particular embodiment where the database 12 and the server 11 are integrated into a single activity status management apparatus 1, the apparatus deduces the terminal 2's activity status information and stores it directly in a status information register.

According to a second embodiment not shown in FIG. 1, a connection of the type TCP is maintained open between the terminal 2's activity status client and the activity status server 11. Maintaining this connection presents the advantage of being very inexpensive and of giving the activity status server 11 an indication of the terminal 2's unavailability when the TCP connection is broken. The activity status database 12 (or the activity status management apparatus 1 in the case where the database 12 and the server 11 are integrated into a single apparatus) can then update the status information register, as described above.

Such an embodiment can present certain difficulties, notably that too many TCP connections must be maintained open simultaneously.

An alternative embodiment can therefore be envisaged, corresponding to a dual mode of operation in which a TCP connection is maintained open between the terminal 2 and the activity status server 11 for a predetermined maximum length of time, for example depending on the operational restrictions of the network 4, and can then be reallocated later on.

It can be envisaged to implement a mode of operation corresponding to a combination of different embodiments presented above. A TCP connection is maintained open between the activity status server 11 and the terminal 2, which periodically transmits IP packets (for “Internet Protocol”) to the server 11 to inform it, amongst others, of its activity status. Thus, to determine whether the terminal 2 is active or inactive, the server 11 can analyse the status of the TCP connection (open or broken), then refine the status information, estimating the length of time passed since the last IP packet was received (inferior or superior to a predetermined threshold).

The server 11 can also refine the waking status information associated with the terminal 2 by analysing the contents of the IP packet received. In fact, according to the invention, the terminal 2's activity status client can insert information relating to the waking status it wishes to indicate to the server 11 into the IP packet transmitted to the server 11. Thus, the terminal 2 can be on, but its user can indicate to the server 11 that he does not wish to be considered active, except in the case of an emergency, for example.

By way of example, the case of a temporary connection can be described, established upon the terminal 2's request. For example, the terminal 2 sends a request of the type HTTP, which entails a request to establish a TCP connection. A client of the terminal 2 can request that the communications network 4, of the type GPRS for example, establish a PDP context (“Packet Description Protocol”). This then entails the reservation of an IP address allocated to the terminal 2, which can then send packets through the GPRS network 4. This context implies that the radio resources are allocated to the terminal 2 when, for example, it sends or receives data.

Such an external IP address is established by the network 4 of the operator for a predetermined time that corresponds to the duration of the establishment of the PDP context.

Such a period of time is superior to the duration of a connection TCP. In addition, the network 4 associates a timer to each PDP context, which is deactivated when the maximum predetermined duration expires. Such a characteristic is necessary for the establishment of a Web session by the terminal 2 because such a session comprises many TCP connections that must however have the same IP address. In addition, it must be noted that a PDP context is costly in terms of network resources.

Such a PDP context thus makes it possible to maintain contact between a public address and a private address on the level of a router (Gateway GPRS Signalling Node) which connects the GPRS network to the worldwide Internet.

If the terminal 2 disconnects this can be detected by the TCP protocol status machines. The activity status server 11 considers, by default, that the terminal 2's status does not change during the period separating two successive connections. In other words, the activity status server 11 exploits the last status information received from the terminal 2 to determine whether it is active or inactive.

In the case where the status information of the terminal 2 has not been updated for a long period of time (and therefore for example if the “PDP context” has expired), the activity status server 11 can modify the status of the terminal 2 which it has stored (and therefore deduce from the expiration of the context that the terminal can no longer be contacted). For example the activity status server 11 can consider the terminal 2 to be unavailable, or inactive if no new status information is transmitted to it for a period of time superior to the predetermined threshold, about 10 minutes for example.

In the example in FIG. 1, the activity status server 11 manages the terminal 2's activity status information, but can also manage data relating to the terminal 2's user subscriber's profile. This data can be stored in the activity status database 12.

The user of the terminal 2 subscribes, implicitly or explicitly, to an activity protocol with the server 11, determining notably the structure of the datagram or the IP packet transmitted to the server 11. In one embodiment of the invention, the activity protocol ensures that the message sent from the terminal 2 to the server 11 comprises a certain number of bits and that each bit is associated with a particular mode of transmission, associated with a class of services offered to the terminal 2.

One service can of course belong to several distinct classes of services if the service provider implements several distinct modes of transmission in order to offer this service to the user. For example, a content provider can choose to transmit contents to the terminal 2 by data transmission of the WAP type and by notification of the SMS type.

Thus, the activity status management apparatus 1 or the activity status database 12 can keep an activity status register up to date, grouping together waking status information of the following structure:

| | |
|---|---|
| Bit 1 | Notification |
| Bit 2 | Normal voice |
| Bit 3 | Urgent voice |
| Bit 4 | Normal WAP Push |
| Bit 5 | Urgent WAP Push |
| Bit 6 | Filtered voice |

Each bit 1 to 6 is associated with a mode of transmission used preferably for a class of services to which the terminal 2 has access via the communications network 4. For example, bit 1 corresponds to the emission and/or reception by the terminal 2 of notifications, for example of the SMS type. Bits 2 and 3 correspond to the possibility of receiving calls of the types normal or urgent. The bits 4 and 5 are associated to data transmission within the framework of WAP protocol.

By way of example, services of the type “alert” linked to the security of goods or of people and services of the type “stock market info,” which typically use a mode of the type WAP Push.

If the user of the terminal 2 sends an IP packet to the server 11 in which all the bits of the above structure are positioned at 1, the server 11 can deduce that the terminal 2 must be considered as active for all mode of transmission mentioned above. Inversely, if all the bits are positioned at 0, the user wishes his terminal 2 to be considered on standby with regard to all the modes of transmission, and therefore does not wish to be disturbed.

If the activity status server 11 receives an IP packet from the terminal 2 in which the bits 1 and 3 of the above structure have the value of 1, and all the other bits have the value of 0, the server 11 can therefore deduce that the user accepts to receive notifications (for example short messages) and urgent calls, but wishes to be considered inactive, and therefore unavailable, for all other modes of transmission implemented in the network 4.

Identification data, called UserID, is in addition associated to the terminal 2's user and is transmitted in the datagram to the activity status server 11. The server 11 can then interpret the protocol used in the IP packet received depending on the identification data. It can in fact store in memory a table associating an activity protocol with each UserID of the radio communications network 4.

For example, the MSISDN of the terminal 2's user can be used as identification data. The use of any other type of identification data can of course be envisaged to enable server 11 to identify the originating point of a datagram or IP packet received.

In addition, if the terminal 2 wishes to access a service offered by a service provider 3 disposing of a particular APN (“Access Point Name”) for its service, the terminal 2's activity status client attaches the public IP address at which the terminal 2's user can be contacted to the datagram transmitted to the server 11 in the IP packet.

In the same manner, if the service provider 3 is connected to the activity status management apparatus 1 or to the activity status database 12 through the worldwide Internet, a TCP connection can be established between the terminal 2 and the apparatus 1 (or the database 12), and authentication data can be added to the IP packet passing between the terminal 2 and the apparatus 1 when the session is established.

The status information relating to the terminal 2, updated by the activity status server 11, can then be made available to service providers 3 over the network 5. Several mechanisms can be envisaged within the framework of the invention to this effect.

Thus, it can be envisaged that the database 12 (or the apparatus 1) stores the addresses of a large number of service providers 3, and that it sends notification to all these service providers 3 each time the activity status information associated with terminal 2 changes in value.

It can also be envisaged that a service provider 3 regularly or upon need carries out a polling of the activity status management apparatus 1 or of the activity status database 12 in order to determine the activity status of terminal 2.

It can also be envisaged, in the framework of the invention, that any other technique enabling a service provider 3 who wishes to determine the waking status relative to a given terminal 2 be implemented.

The invention as illustrated in FIG. 1 also enables the activity status server 11 to send notification to terminal 2's user. In other words, the activity status server 11 can transmit a particular piece of information to the terminal 2, or a notification instructing the user to pick up some particular data. For example, the server 11 can invite terminal 2's user to go to a WAP page containing notification information intended for terminal 2.

FIG. 2 presents an example of embodiment of the invention in which a TCP connection remains open between the terminal 2 and the activity status server 1. According to the TCP protocol, the terminal 2 regularly sends (21) a synchronisation message, called SYN, to the activity status server 11. For example, a SYN is sent every 14 seconds.

The server 11 acknowledges (22) the SYN received, and the terminal 2 acknowledges (23) in turn the acknowledgement received by the server 1.

An initial piece of data is sent (24) by the terminal 2's activity status client to server 11 when the TCP connection is initialised. Such an initial piece of data comprises for example the UserID identification data of the terminal 2's user, the public IP address at which he can be contacted, authentication data and the waking status information which the user wishes to signal to the server 11. Afterwards, only the SYN relating to the maintenance of the connection and the states of readiness, containing data on the terminal 2's activity status, are sent to the server 1.

According to this embodiment, beyond the establishment of the connection, at which time a large quantity of data is exchanged between the terminal 2's activity status client and the server 1, it should be noted that the volume of user data transmitted by the terminal 2 is advantageously small.

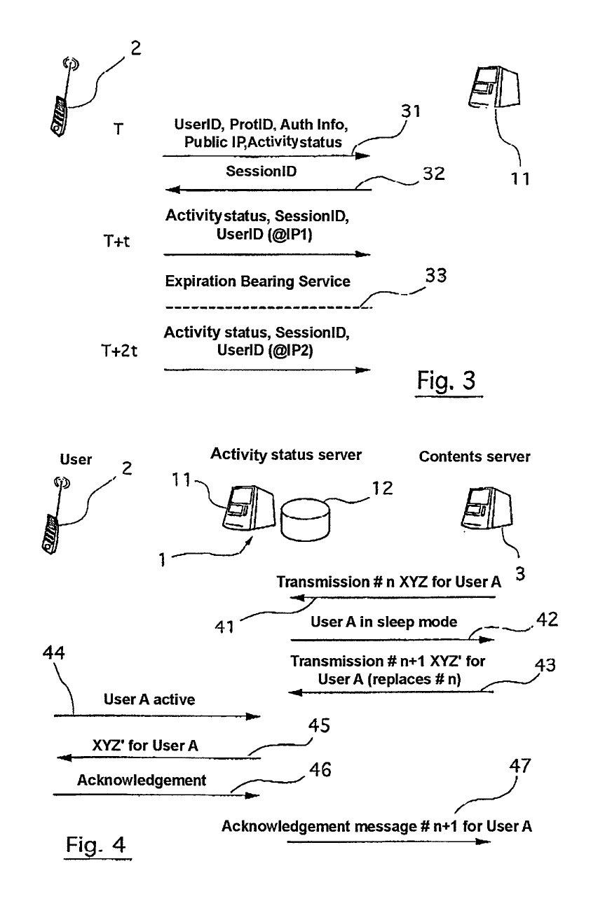

In FIG. 3, an example of the implementation of the invention similar to that described in FIG. 2 is shown, but in which the protocol used is the UDP protocol. In the example in FIG. 3, the terminal 2 belongs to a radio communications network 4 using the standard GPRS.

It should be noted that the UDP protocol is the protocol used by the WAP protocol for transmission between the mobile terminal and the WAP gateway. When a message is sent, a bearer connection is established in the GPRS network 4 between the mobile terminal 2 and the GPRS gateway Service Node, called GGSN. This bearer connection will be maintained in the network for a configurable time, independent of the service running over the UDP. It should be noted that a bearer connection is a low-level connection that makes it possible to transport IP packets between two points. By way of example, the PDP protocol (“Packet Description Protocol”) can be considered, as used in a modem connection.

The GGSN gateway then maintains a correspondence between the IP address allocated dynamically to terminal 2 during the establishment of the bearing connection, and the identification data of terminal 2.

A notion of session over the UDP protocol must be reconstituted, associating the identification data of terminal 2's user (that is to say his UserID, for example his MSISDN) and a changing IP address.

As illustrated in FIG. 3, the activity status client implemented by the terminal 2 therefore sends (31) initialisation data to server 11, comprising notably its UserID, authentication information, the public IP address at which it can be contacted and data concerning its status.

A session is then established, and the server 1 sends (32) data called SessionID to terminal 2, making it possible to identify the session. A first IP address, shown as @IP1 in FIG. 3, is associated with terminal 2.

In the examples presented in relation to the FIGS. 2 and 3, the data packets sent by the terminal 2 to server 11 contain little information. It can therefore be envisaged in the framework of the invention that the server 11 sends a response to terminal 2 upon reception of the data packets. Such a response, or return data, can for example be data of the Push type, that is to say a notification. More generally, the structure of the return data can use the principles of e-mail, of the Web and of the SIP protocol, and for example be constituted of data blocks of the MIME type.

It can for example be envisaged that such return data present the following structure:

Normal Voice

Notification in Vmail

Urgent Voice

Notification in Vmail

Normal WAP Push

Urgent WAP Push

Urgent e-mail

Normal e-mail

“SMS like message”

Thus, the field “Voice Notification” makes it possible to indicate to the user that he should consult his voice mailbox, and the fields “Normal WAP Push” and “Urgent WAP Push” make it possible to indicate to the user that he can consult a WAP page (of the type Push).

FIG. 4 shows the manner in which the invention is implemented when a service provider 3 wishes to send a notification to terminal 2's user.

During the step numbered 41, the service provider 3 sends contents XYZ to the activity status management apparatus 1, intended for terminal 2's user.

The apparatus 1 (for example through the database 12 illustrated in FIG. 1) sends back (42) data indicating that the terminal 2 is on standby with regard to this type of service.

During the step numbered 43, the service provider 3 sends a new contents XYZ′ to the apparatus 1, destined to replace the contents XYZ previously transmitted.

The apparatus, having received (44) from the terminal 2 data indicating that it is active, transmits the contents XYZ′ to terminal 2 during the step numbered 45. For example, in a particular embodiment where the apparatus 1 comprises an activity status server 11 and a distant activity status database 12, server 11 transmits the contents XYZ′ to terminal 2, upon validation by the database 12 of the active status of terminal 2.

The terminal 2 can then acknowledge (46) reception of the contents. The activity status management apparatus 1 acknowledges (47) in turn the transmission of the message with the contents XYZ′ to the terminal 2, with the service provider 3.

It should be noted that, in the example in FIG. 4, the activity status management apparatus 1 plays a role close to that of systems which transmit short messages of the type SMS of the prior art, without however being connected to the HLR implemented in classic radio communications networks.

1. Activity status management method for at least one terminal in a radio communications network, the said network permitting access from the said terminal to at least one service,
characterised in that it implements an analysis step, using an activity status management apparatus, of the activity of the said terminal,
in such a manner as to deduce information as to the activity status of the said terminal,
the said apparatus being connected to the said radio communications network but not being included in the architecture of the said network,
the said activity status information being accessible to at least one service provider internal or external to the said radio communications network.

2. Management method according to claim 1, characterised in that the said activity status management apparatus comprises:
at least one activity status server implementing the said analysis step;
at least one activity status database implementing a storage step in which the said activity status information is stored.

3. Management method according to claim 2, characterised in that the said database is accessible via the said radio communications network and/or via at least one other communications network.

4. Management method according to claim 3, characterised in that during the said analysis step, the said activity status server analyses the status of a connection established between an activity status client implemented by the said terminal and the said activity status server,
and in that the said activity status information takes on a first value of “active” when the said connection is open, and a second value of “inactive” when the said connection is broken.

5. Management method according to claim 2, characterised in that during the said analysis step, the said activity status server analyses the status of a connection established between an activity status client implemented by the said terminal and the said activity status server,
and in that the said activity status information takes on a first value of “active” when the said connection is open, and a second value of “inactive” when the said connection is broken.

6. Management method according to claim 5, characterised in that the said connection is implemented using a protocol of the TCP (“Transmission Control Protocol”) type.

7. Management method according to claim 5, characterised in that the said connection expires after a maximum predetermined time and is reallocated later on to the said power status client of the said terminal.

8. Management method according to claim 2, characterised in that during the said analysis step, the said activity status server analyses the length of time since reception of the last packet transmitted by an activity status client implemented by the said terminal to the said activity status server,
and in that the said activity status information takes on a value of “active” when the said length of time is inferior to a predetermined threshold, and a second value of “inactive” when the said length of time is superior to the said threshold.

9. Management method as claimed in any of the claim 8, characterised in that the said status message comprises in addition at least one of the following pieces of information:
authentication information;
a public IP (“Internet Protocol”) address of the said user.

10. Management method as claimed in claim 2, characterised in that it comprises in addition an availability step in which the said activity status information is made available to at least one of the said service providers by the said activity status database.

11. Management method according to claim 10, characterised in that during the said availability step, the said database transmits the said activity status information in reply to a query from the said service provider.

12. Management method as claimed in claim 10, characterised in that the said activity status database implements the said availability step each time the value of the said activity status information changes.

13. Management method as claimed in claim 1, characterised in that the said analysis step comprises a sub-step in which the said activity status information is refined in such a manner as to provide data selectively on the activity status of the said terminal with regard to a mode of transmission associated with a class of service(s).

14. Management method as claimed in claim 1, characterised in that during the said analysis step, the said activity status server analyses the contents of a status message transmitted by an activity status client implemented by the said terminal to the said activity status server, in such a way as to deduce the said activity status information of the said terminal.

15. Management method according to claim 14, characterised in that the said status message is a binary message comprising a plurality of bits, each of the said bits being associated with at least one mode of transmission,
and in that during the said refining sub-step, the said activity status server determines the value of each bit and deduces the activity status of the said terminal with regard to the said at least one mode of transmission associated,
a bit of value 0, respectively 1, indicating that the said terminal is in an active, respectively inactive, state, for the said transmission modes associated, or vice versa.

16. Management method as claimed in claim 14, characterised in that the exchanges between the said activity status client implemented by the said terminal and the said activity status server are carried out according to a definite activity protocol, defining a structure of the said status message.

17. Management method as claimed in claim 14, characterised in that the said status message comprises in addition identification data for a user of the said terminal.

18. Management method according to claim 17, characterised in that the said activity status server determines the said activity protocol implemented, depending on the said identification data.

19. Management method as claimed in claim 1, characterised in that it comprises in addition a transmission step in which the said activity status server transmits an informative message to the said user.

20. Management method according to claim 19, characterised in that the format of such an informative message is that of the MIME type (“Multipurpose Internet Mail Extension”).
